(19) United States
(12) Patent Application Publication
(10) Pub. No.: US 2026/0326905 A1
(43) Pub. Date: Oct. 22, 2026

(54) AIRCRAFT PROPULSION SYSTEM AND AN AIRCRAFT

(71) Applicant: Airbus Operations SAS, TOULOUSE (FR)

(72) Inventors: Pierre-Antoine COMBES, TOULOUSE (FR); Nicolas JOLIVET, TOULOUSE (FR); Fabrice GRIMAL, TOULOUSE (FR); Olivier PAUTIS, TOULOUSE (FR)

(21) Appl. No.: 19/649,689

(22) Filed: Apr. 16, 2026

Related U.S. Application Data
(60) Provisional application No. 63/790,519, filed on Apr. 17, 2025.

(51) Int. Cl. B64D 27/40

(52) U.S. Cl. CPC B64D 27/402

(57) ABSTRACT

A mounting assembly for securing an aircraft engine to a wing via a pylon. The mounting assembly including a front engine mount with a triangular piece extending between a front engine lug and three connection points to the pylon. The assembly also includes two shackles extending between pylon lugs and engine lugs. One of the connection points between the triangular piece and the pylon is a waiting fail safe connection.

### CROSS-REFERENCE TO RELATED APPLICATIONS

This application which claims the benefit of U.S. Pat. Application Ser. No. 63/790,519, filed on Apr. 17, 2025, the entire disclosures of which are incorporated herein by way of reference.

### FIELD OF THE INVENTION

The present invention relates to an aircraft propulsion system and an aircraft with a propulsion system, and in particular wherein the propulsion system includes a turbojet engine and attachment means for securing the turbojet engine to the aircraft.

### BACKGROUND OF THE INVENTION

An aircraft conventionally has a plurality of propulsion systems. Each propulsion system is generally secured underneath a wing of the aircraft and includes a powerplant, for example, a turbojet engine, secured under the wing and attachment means for securing the turbojet engine under the wing.

Although current propulsion systems are satisfactory and meet the necessary requirements, the assembly and disassembly of the attachment means or mounting assemblies which connect a pylon and an engine are generally lengthy and complex. There is an ongoing need and desire to provide to mounting assemblies that reduces installation time and complexity while meeting the necessary requirements.

### SUMMARY OF THE INVENTION

New engine mounting assemblies have been invented. The new engine mounting assemblies do not generate major aero hard-points for external aerodynamic lines. Additionally, in the new engine mounting assemblies, failsafe scenarios are fully considered. Further, the engine mounting assemblies architecture is defined so that the loads at each interface are reasonable and well distributed between each interface. In addition to meeting the foregoing requirements, in the new engine mounting assemblies, the engine to pylon interfaces provide an easy/simple accessibility for engine installation/removability.

According to one or more aspects, the present invention may be characterized as providing a mounting assembly for securing an aircraft engine to a wing via a pylon, the mounting assembly comprising: a front engine mount disposed above a fan casing of the aircraft engine, the front engine mount including: a triangular piece extending between a front engine lug of the aircraft engine and a beam lug of the pylon, and two shackles extending between respective pylon lugs and respective middle engine lugs, wherein the triangular piece is connected to the beam lug by three connection points, and, wherein the front engine mount is configured to provide a fail-safe load path such that, upon failure of one of the connection points, loads are transferred through at least another of the connection points to maintain attachment of the aircraft engine to the pylon.

The triangular piece may be connected to the aircraft engine at a single engine fixation point. The single engine fixation point may include includes a double axis providing fail-safe protection.

Two of the three connection points may be bearing interfaces and the other connection point of the three connection points may be a waiting fail-safe (WFS) interface. The WFS interface may be configured to take up loads only upon failure of another connection point. The WFS interface may not include a bearing.

Each of the two shackles may extend between the pylon lugs and the middle engine lugs in a generally vertical direction.

Each of the two shackles may be doubled to provide fail-safe functionality. Each shackle may be coupled to the pylon through a doubled axis.

The front engine mount may define a dual load path such that loads are transmitted along longitudinal, transverse, and vertical axes through two different paths while limiting introduction of bending moments into the front engine mount.

The mounting assembly may also include: a rear engine mount including rear rods extending between the aircraft engine and the pylon. The rear rods may be doubled.

According to one or more aspects, the present invention may also be characterized as providing an aircraft comprising: a wing; an engine having a fan casing; a pylon secured to the wing; and a mounting assembly as described herein securing the engine to the pylon.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

The characteristics of the invention will emerge more clearly from a reading of the following description of at least one example of embodiment, said description being produced with reference to the accompanying drawings, among which:
FIG. 1 is a side view of an aircraft comprising an assembly according to the invention;
FIG. 2 is a side view of an assembly according to the invention;
FIG. 3A is a schematic representation of conventional structure with single load paths;
FIG. 3B is a schematic representation of structure with dual load paths;
FIG. 4 is a side view of an assembly according to the invention showing loads taken up by the components of the assembly;
FIG. 5 is a top view of an assembly according to the invention;
FIG. 6 is a schematic view of FIG. 7 is a top view of an assembly according to the invention showing loads taken up by the components of the assembly;
FIG. 8 is a side view of an assembly according to the invention showing loads taken up by the components of the assembly in case of a failure; and,
FIG. 9 is a top view of the assembly in FIG. 8 showing the loads taken up by the components of the assembly in case of a failure.

In general, the same reference numbers will be used throughout the drawing(s) and accompanying written description to refer to the same or like parts.

### DETAILED DESCRIPTION

As mentioned above, new engine mounting assemblies have been invented.

FIG. 1 shows an aircraft 10 which has a propulsion system 100. The aircraft 10 has, on both sides of a fuselage 12, a wing 14 to which an engine pylon 102 is fixed. The propulsion system 100 generally includes the engine pylon 102 and an engine 104.

In the following description, and by convention, X is called the longitudinal axis of the engine oriented positively in the direction of advance of the aircraft 10, it is called Y, the transverse axis of the engine which is horizontal when the aircraft is on the ground, and Z, the vertical axis or vertical height when the aircraft is on the ground, these three axes X, Y and Z being mutually orthogonal. The fore and aft positions are taken in relation to the forward and aft of the aircraft 10. The direction of advancement of aircraft 10 is given by the arrow F which shows the direction in which aircraft 10 advances when engines 104 are running. The engine 104 has a vertical median plane P (XZ).

In the frame of the aircraft engine 104 with high loads to be transferred from the engine 104 to the wing 14, there are specific requirements for engine mounts systems between the pylon 102 and the engine 104.

The new engine mounting assemblies 200 are shown in FIGS. 2 and 4-9 with front engine mounts 202. The new engine mounting assemblies 200 also include rear engine mounts 203 with rear rods 204 connecting the core of the engine 104 to the pylon 102. The front engine mounts 202 are disposed above the fan casing 206 of the engine 104, and utilize a single triangular piece 208 is provided to transfer loads as shown in FIGS. 4 and 7.

As may be used herein, a “dual load path” refers to a structure that is fail safe when it is damage tolerant: in case of failure or rupture (total or partial) of one of its components, it can continue to ensure its functions, at least up to the next inspection control. To continue performing these functions, the constituent elements are doubled. The two-part main support allows the transmission of loads along the X, Y and Z axes via two different paths. This design does not introduce any moment into the front support or into the forward mount. A conventional structure is shown in FIG. 3A and an example dual load path structure is depicted in FIG. 3B.

Turning to FIG. 5, the single triangular piece 208 is secured to the engine 104 by one fixation point 209a and secured to the pylon 102 by three fixation points 209b, 209c, 209d. The engine fixation point 209a includes a double axis for fail-safe protection. On the pylon, the fixation points 209b, 209d on the outside may be simple axes, whereas the middle fixation point 209c is a waiting fail safe (WFS) axis. As can be seen in FIG. 6, the double axes (FS) point and simple axis contain bearings whereas the WFS axis does not.

The single triangular piece 208 is connected at the engine fixation point 209a to the engine 104 via a front engine lug 215. The single triangular piece 208 is connected at the pylon fixation points 209b, 209c, 209d to the pylon 102 via a beam with lug 212.

As shown in FIGS. 4 and 5, the front engine mounts 202 also includes front shackles 214 with interfaces distributed within the volume of the front rib 106 (called N1) of the pylon box 108. The front shackles 214 extend between pylon lugs 216 and mid engine lugs 218. The compact design optimizes the aerodynamic integration of the area, which is very sensitive because it is blown by the fan jet and close to the propeller of the engine 104.

The load inputs are aligned with the main webs of the structural partitions constituting the pylon box 108: the vertical shackles 214 borne by the lateral panels of the front rib 106 are contained in a XZ-plane. Their projection is in a pure Z-direction (vertical) so that they ensure the balancing of the MX (Engine Torque).

The axis of the shackles 214 goes through the lateral panels and the strong rib 106, thus loading both parts in shear and preventing the introduction of additional moments in the pylon box 108.

According to the present invention, the following components form the fail-safe system: front triangle including the following doubled elements:
front engine lug 215, engine front rod axis, front triangle 208, pylon axis;
rear rods including the following doubled elements: rear engine lug, engine rear rod axis, rear rod 204, pylon axis; and,
shackles including the following doubled elements:
   engine yoke, engine shackle axis, shackle 214, pylon shackle axis, beam with lug 212, pylon lugs 216, first rib 106 (inboard and outboard).

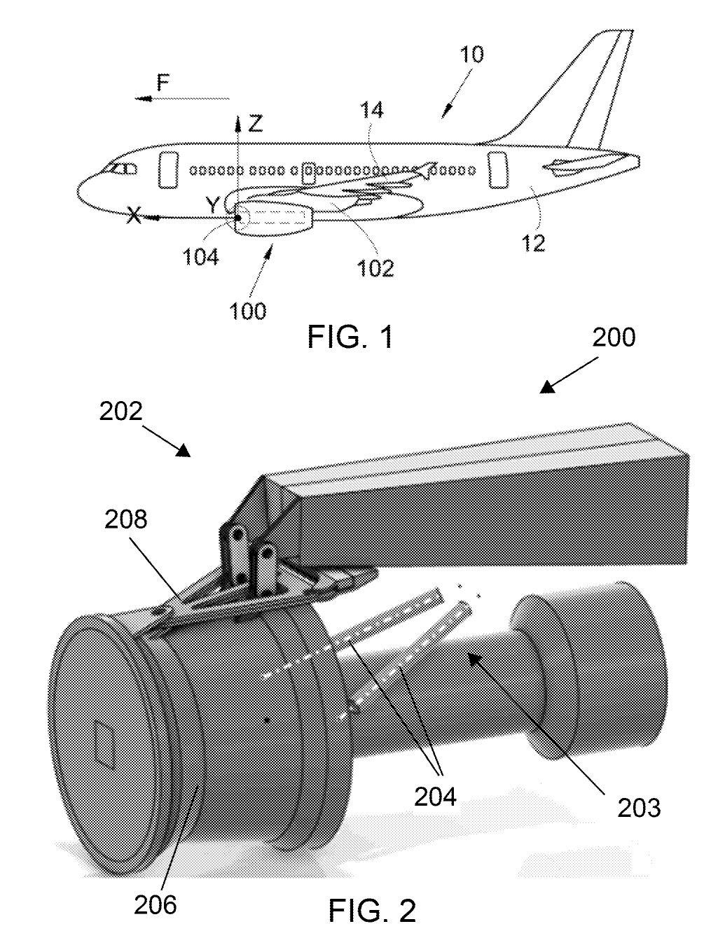

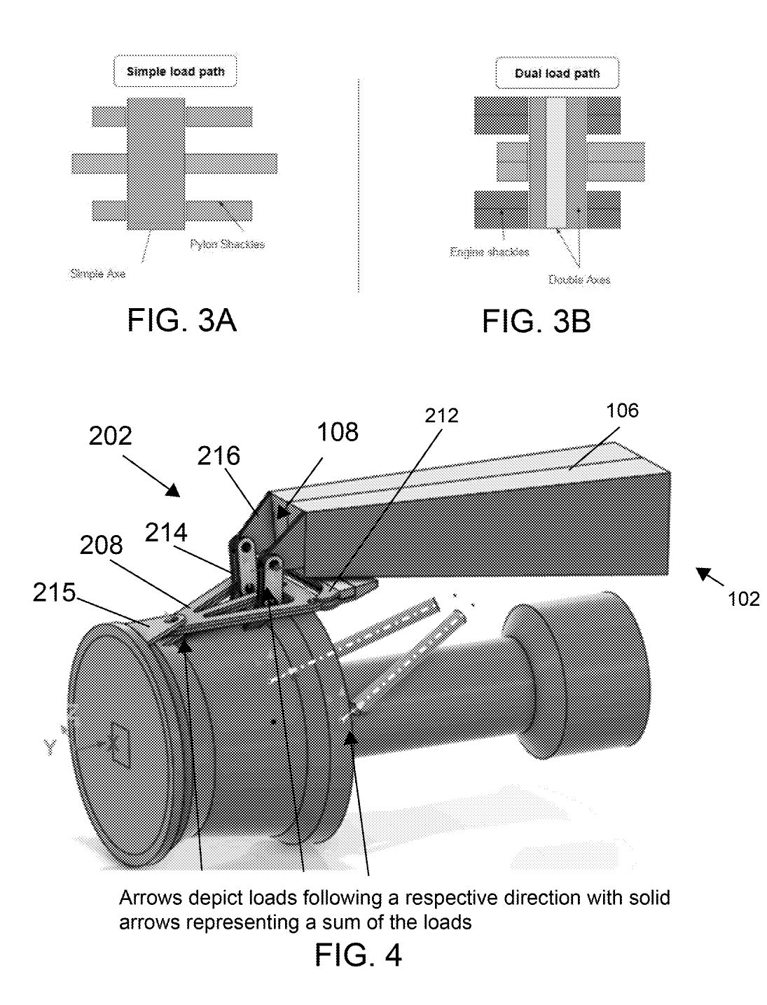

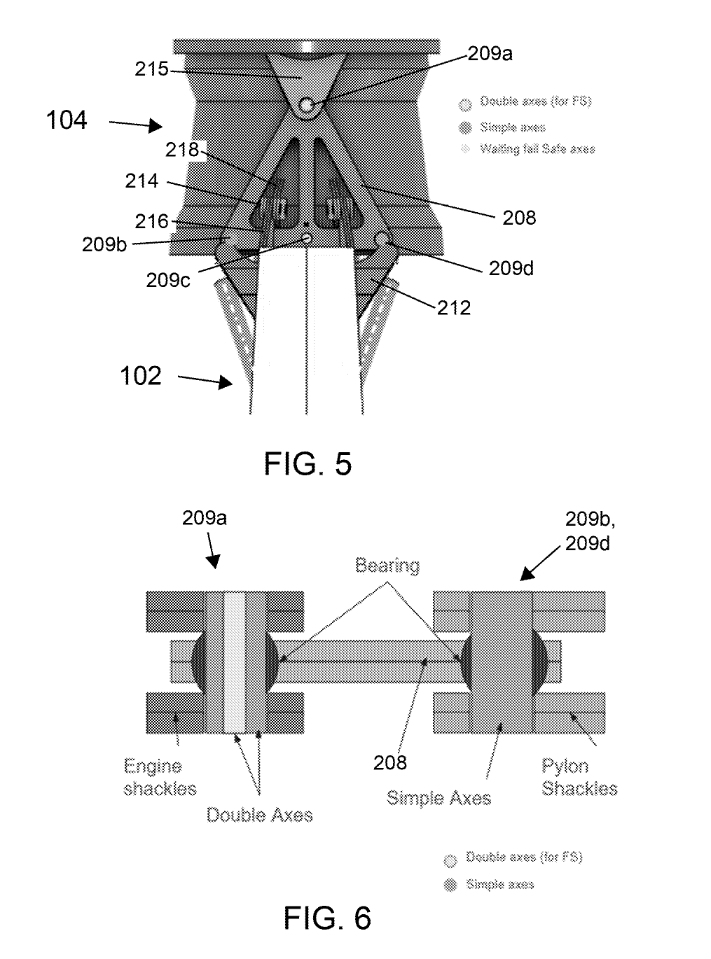

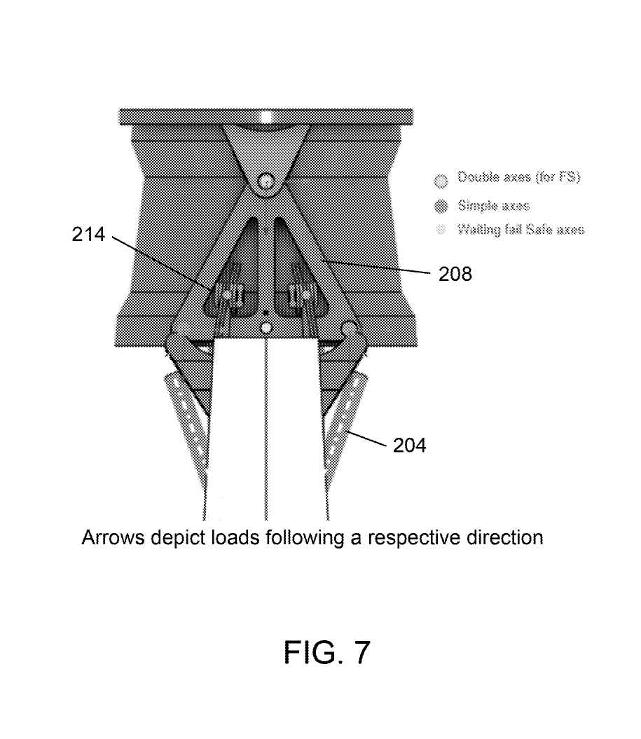

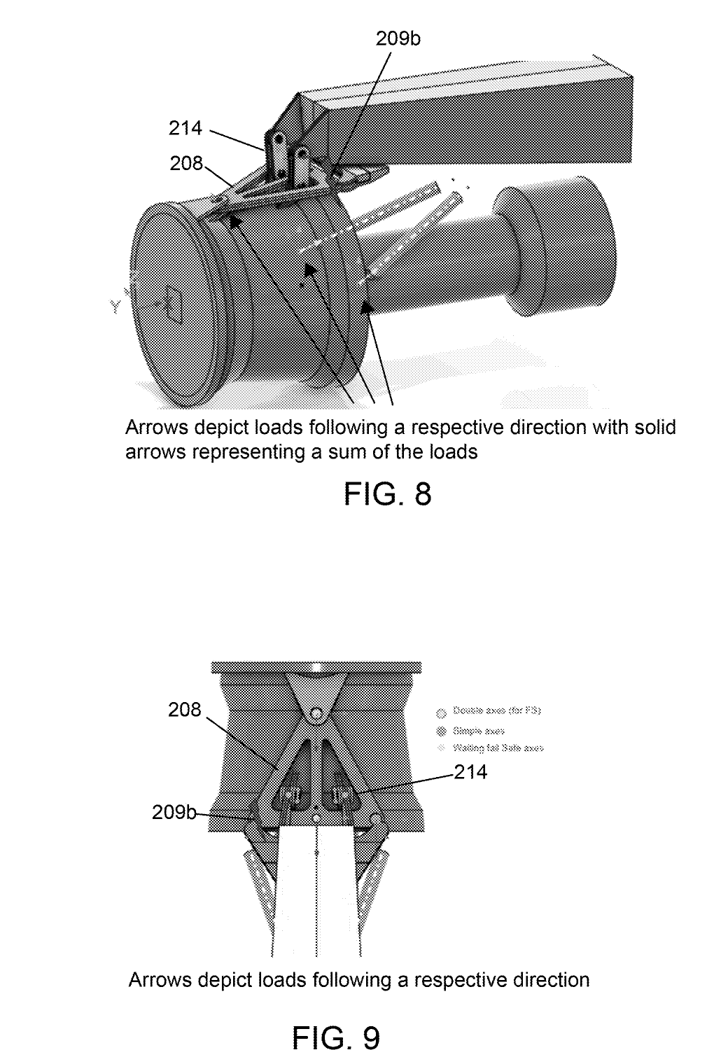

FIGS. 8 and 9 show the loads being transferred in case of a failure of one of fixation points 209b.

The compact aspect of the depicted embodiment mitigates potential impacts on external aerodynamic lines and associated drag penalties. The several rods ensure the transfer of loads while being contained within the nacelle lines. The depicted embodiment enables an efficient integration of the power plant system from both an A/C and engine standpoint.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A mounting assembly for securing an aircraft engine to a wing via a pylon, the mounting assembly comprising:
a front engine mount disposed above a fan casing of the aircraft engine, the front engine mount including:
a triangular piece extending between a front engine lug of the aircraft engine and a beam lug of the pylon, and
two shackles extending between respective pylon lugs and respective middle engine lugs,
wherein the triangular piece is connected to the beam lug by three connection points, and,
wherein the front engine mount is configured to provide a fail-safe load path such that, upon failure of one of the three connection points, loads are transferred through at least another of the three connection points to maintain attachment of the aircraft engine to the pylon.

2. The mounting assembly of claim 1, wherein the triangular piece is connected to the aircraft engine at a single engine fixation point.

3. The mounting assembly of claim 2, wherein the single engine fixation point includes a double axis providing fail-safe protection.

4. The mounting assembly of claim 1, wherein two of the three connection points comprise bearing interfaces and the third connection point of the three connection points comprises a waiting fail-safe (WFS) interface.

5. The mounting assembly of claim 4, wherein the WFS interface is configured to take up loads only upon failure of another connection point.

6. The mounting assembly of claim 4, wherein the WFS interface does not include a bearing.

7. The mounting assembly of claim 1, wherein each of the two shackles extends between the pylon lugs and the middle engine lugs in a generally vertical direction.

8. The mounting assembly of claim 1, wherein each of the two shackles is doubled to provide fail-safe functionality.

9. The mounting assembly of claim 8, wherein each shackle is coupled to the pylon through a doubled axis.

10. The mounting assembly of claim 1, wherein the front engine mount defines a dual load path such that loads are transmitted along longitudinal, transverse, and vertical axes through two different paths while limiting introduction of bending moments into the front engine mount.

11. The mounting assembly of claim 1, further comprising:
a rear engine mount including rear rods extending between the aircraft engine and the pylon.

12. The mounting assembly of claim 11, wherein the rear rods are doubled.

13. An aircraft comprising:
a wing;
an engine having a fan casing;
a pylon secured to the wing; and
the mounting assembly of claim 1 securing the engine to the pylon.
